(19) United States
(12) Patent Application Publication
(10) Pub. No.: US 2008/0098034 A1
(43) Pub. Date: Apr. 24, 2008

(54) Method Of Updating Content Of A Portable Device

(75) Inventors: Hendrikus Bernardus Van Den Brink, Eindhoven (NL); Jozef Pieter Van Gassel, Sevenum (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,742

(22) PCT Filed: Dec. 21, 2005
(86) PCT No.: PCT/IB05/54358

§ 371 Date: Jun. 25, 2007

(30) Foreign Application Priority Data
Jan. 4, 2005 (EP) 05100019.8

(51) Int. Cl. G06F 17/30

(52) U.S. Cl. 707/104.1; 707/E17.009

(57) ABSTRACT

The invention describes a method of updating content of a portable device (1) with a file system (14) for managing the content (F₁, F₂, . . . , Fₙ), an associated file system table (2), and a content database (3) for presenting the content (F₁, F₂, . . . , Fₙ) according to content metadata (M₁, M₂, . . . , Mₙ), which method comprises establishing a connection between the portable device (1) and a main device (4), replicating at least part of the current file system table (2) to give a primary file system table replica, modifying the content (F₁, F₂, . . . , Fₙ) of the portable device (1) by means of the main device (4), comparing the modified file system table (2′) to the primary file system table replica (2) and updating the content database (3) of the portable device (1) on the basis of the comparison results. Furthermore, the invention describes a system (5) for updating content (F₁, F₂, . . . , Fₙ) of a portable device (1), and a portable device (1).

### FIELD OF THE INVENTION

The invention relates to a method of updating content of a portable device.

The invention further relates to a system for updating content of a portable device.

The invention further relates to a portable device.

### BACKGROUND OF THE INVENTION

In recent years, portable storage devices have gained immensely in popularity owing to their ability to store large amounts of data in spite of their compact size. The data or files stored on such a device are collectively referred to as the “content”, and might be audio, video, music, or any kind of data. Generally, such files are stored in a format containing descriptive metadata in addition to the actual file data, e.g. a descriptive header to accompany image or music data. An example of such a format is the popular MP3 format, which allows music files and associated metadata to be stored in a compact manner. The metadata for a music file, for example, might contain descriptive information such as artist, album name, song title, song duration, genre, etc., and can be used to categorize each piece of music on the portable device. A portable storage device, whose main function is content playback, is often simply referred to as a player, e.g. a music player. Such a music player can be capable of storing several thousands of tracks, or pieces of music, and can also store other content such as notes entered by a user.

To make it easy for the user to find a certain file from among the large amounts of data stored on the device, a database in the portable device is usually used to present the content in a user-friendly and intuitive manner. The database can present the content of the device to the user in an intuitive manner by showing dynamic views of the content in a display of the portable device. For example, artist, genre, etc. might categorize a collection of songs in a music database, so that the categories can be visually presented to the user in folders named “Artist”, “Genre”, “Album”, etc. Evidently, any music file can be placed in a number of different categories.

Owing to their compact size, certain types of portable device such as the player mentioned above generally do not avail of an operating system or extensive user interface, so that acquisition of data for the portable device is generally done with the aid of another device such as a PC. Data can be copied or downloaded to the PC from another source—for example, a private music collection or an internet music shop—and moved from the PC onto a portable device or player by means of a suitable connection such as USB (universal serial bus), WLAN (wireless local area network), Bluetooth etc.

However, even though it is relatively easy to transfer data or content to the portable device, for example by using the commonly known “drag and drop” technique, it is still necessary to update the database on the portable device. Most portable devices are supplied with software, which can be installed on the PC, and can be used to manage the content and update the database of the portable device. However, the user can only update the content database of his portable storage device using his own PC or another PC upon which the necessary software has already been installed. If he transfers content to the portable device from another device or from another source, without using the software required for updating the database, the content database will not be updated. To manually update the database in this case, the user generally has to navigate though a menu structure on the portable storage device until he arrives at the appropriate command for updating the database. Should he omit or forget this step, the database will not reflect the actual content of the portable device. However, most devices do not offer this possibility at all, thus limiting the user to perform any updates by using the dedicated software installed on the PC for updating the database of the portable device.

### OBJECT AND SUMMARY OF THE INVENTION

Therefore, an object of the present invention is to provide an intuitive and user-friendly way of automatically updating the database of a portable device, in particular the above-mentioned type, without requiring user intervention.

To this end, the present invention provides a method of updating content of a portable device with a file system for managing the content, an associated file system table, and a content database for presenting the content according to content metadata, which method comprises the steps of establishing a connection between the portable device and a main device and replicating at least part of the current file system table to give a primary file system table replica. Content of the portable device is then modified by means of the main device. Thereafter, the modified file system table is compared to the primary file system table replica, and the content database of the portable device is updated on the basis of the comparison results.

As regards the invention, a “file system” of a device is a system of structured organization of storage space for managing a number of files stored on the device, and can be any appropriate type of structured organizational system. A “file system table” can be visualised as one or more tables or lists containing, among others, file system administration data structures, such as a reference to each file and a pathname giving the location of the file on the device. Furthermore, the file system table might record properties of each file such as file type, the date of last modification of the file, a checksum or file hash for the file, etc. When a file is created or copied to the device, a new reference to this file is generated in the file system table, and the properties of the file are recorded for future reference. To remove or delete a file from the device, it is sufficient to remove the reference to this file from the file system table. Thus, any changes to the files of the device are tracked in the file system table.

As described above, the files stored on a portable device according to the invention can be any appropriate type of file, for example simple files such as text files and/or more complex types of file such as audio/video files. Some properties of the files, such as file type and file size, can be directly recorded in the file system table. More complex file formats such as those used to encode audio and/or video data include additional descriptive metadata in the body of the file describing the file itself. To organise the files in categories, based on metadata information extracted from the files, and to present them in a form suitable for displaying on a display of the portable device, a content database, or content database program, is used according to the present invention. The content database generally presents the actual state of the file system in a hierarchical manner. Categories of the database may be specified by the user or assigned automatically.

The method according to the invention makes use of the information stored in the file system table of a device to automatically update the database. By replicating the file system tables before a modification to the file system takes place, and by comparing the primary file system table replica to the modified file system table, all relevant information describing the modifications made to the file system can be deduced. Using this information, the database can be updated to reflect the actual state of the file system. A particularly advantageous characteristic of the invention is that the content database of the portable device can be updated without any user intervention, and without the need for dedicated software or computer program to explicitly perform the content database update. Modifications to the content of the portable device can therefore be carried out using any suitable main device, such as any computer, mobile telephone, personal digital organizer, with which the portable organizer is capable of establishing a connection for the transfer of data.

Another particularly advantageous characteristic of the invention is that, by storing a replica of the file system tables, loss of data can be prevented which might otherwise occur should the connection to the main device be broken unexpectedly or too soon.

An appropriate system for updating content of a portable device comprises a file system for managing the content of the portable device, an associated file system table, a content database for presenting the content of the portable device according to content metadata, and a replication unit for replicating at least part of the file system to give a primary file system replica. Furthermore, the system comprises a main device for modifying the content of the portable device, and a connecting means for establishing a connection between the portable device and the main device. The system also comprises a comparator for comparing the modified file system to the primary file system replica, and an update unit for updating the content database of the portable device on the basis of the comparison results.

A portable device according to the invention comprises a file system for managing the content of the portable device, an associated file system table, a content database for presenting the content of the portable device according to content metadata, and a connecting means for establishing a connection to a main device for modifying the content of the portable device, e.g. an interface unit for transferring commands and/or data between the main device and the portable device. Furthermore, the portable device also comprises a replication unit for replicating at least part of the file system to give a primary file system replica, a comparator for comparing the modified file system to the primary file system replica, and an update unit for updating the content database of the portable device on the basis of the comparison results. The storage medium of the portable device can be any suitable medium such as a hard disk, memory chip, SMART card, optical disk, etc. Such a portable device generally also comprises a display unit to allow the user of the device to see a representation of the content stored on the device, where the representation is constructed or deduced from the metadata of the content files. For example, an appropriate icon and song title and, perhaps, the corresponding album name can represent music files. The portable device might also comprise a navigational means such as one or more buttons, to allow the user to visually navigate through the database hierarchy.

The dependent claims and the subsequent description disclose particularly advantageous embodiments and features of the invention. Thereby, the system and the portable device can be developed according to the dependent method claims.

The main device can be any appropriate device such as a PC, a mobile telephone, the internet, etc. A connection might be established between the portable device and the main device in a manner depending on the interfaces available to the portable and main devices. For example, the devices might feature a USB interface, or they may communicate in a wireless manner by means of a W-LAN connection or a Bluetooth connection. Information is exchanged between the portable device and the main device using the protocol suitable to the interface being used. The invention is particularly advantageous for devices that expose their disc on a block level, e.g. through the USB mass storage profile—which has attained widespread use for most kinds of personal computer—or the IEEE 1394 SBP-2 profile, so that the main device can also modify the file system table.

A connection might be established in a number of ways, for example by executing an appropriate command via a user interface of the main device or portable device, or by connecting a cable between the two devices. As soon as the portable device notices that a connection is being established, its replication unit can generate a primary copy or replica of the file system table and store this for later use.

In one preferred embodiment of the invention, the modified file system table is automatically compared to the primary file system table replica when the portable device is disconnected again from the main device. Disconnection might be effected by software, or by simply pulling the cable, if a cable is being used, from the appropriate socket.

In a further preferred embodiment, a copy of the file system table is made whenever the content database has been updated, so that a primary file system table replica is ready for use whenever a further update is initiated by the user, thus obviating the need to make a primary file system table replica the next time modifications are carried out to the content. An obvious advantage of this embodiment is that, since the primary file system table replica is already available, no further time need be lost in copying the file system table, and data transfer can take place immediately after a connection is established.

The comparator can compare the primary file system table replica to the modified file system table in a number of ways. For example, it might make a detailed comparison and identify each modification that has been made. Such a detailed comparison might result in information regarding every file that has been added, edited, or removed from the file system. A superficial comparison, on the other hand, might be arrived at by comparing the sizes of the file system table and primary file system table replica, and making a conclusion as to the extent of the modification. For instance, it might be easier, after a relatively large number of modifications have been carried out, to simply build the entire database again. Therefore, in one embodiment of the invention, scanning the content metadata of all the files listed in the modified file system table and building the content database according to information obtained from the content metadata effect the database update.

However, a user will often only add a small number of files to his portable device, or might delete a few files, so that, in a preferred embodiment of the invention, the database is updated by only removing database references to content that has been deleted from the portable device and/or generating database references to content that has been added to the portable device, since it may be faster to perform an incremental database update. Such a partial database update may require less effort than building the database from scratch, particularly when the number of modifications made to the file system is relatively low.

In a further preferred embodiment of the invention, the file system table can be replicated at intervals while the portable device is connected to the main device. For example, a copy of the file system is made whenever a modification has been carried out. In this way, the database can be updated incrementally after every modification to the file system. Each modification can thus be made visible to the user in the display of the portable device, effectively as soon as it is carried out, and the user does not have to wait until he is finished adding or deleting content files before being able to see the results of his modifications in the display of the portable device.

Since the steps of comparing the current file system table to the primary file system table replica and updating the database will take a certain amount of time, a particularly preferred embodiment of the invention utilises a further file system table replica in order to avoid a collision situation which might arise when a further modification is scheduled while the comparator and update units are still busy including the previous modification. In this embodiment of the invention, the current file system table is replicated at a particular point in time, for example when there is no activity on the interface between the main device and the portable device, to give a secondary file system table replica. Once the content database has been updated to reflect the modifications described by the difference between the secondary file system table replica and the primary file system table replica, the secondary file system table replica replaces the primary file system table replica in order to give a new primary file system table replica. In this way, the comparator and database update units have sufficient time to fulfil their functions in the background, and no data transfer delays need arise on the interface. The database update procedure is therefore completely transparent to the user.

The portable device might interpret the commands being transferred from the main device to the portable device, in order to determine whether any modifications have actually been carried out. For instance, it may be that a connection is established between portable device and main device, and the user might carry out some actions on the main device pertaining to the portable device without actually making any changes to the content on the portable device. For example, the user might initially cause a file to be downloaded and then change his mind and delete the file again. The net outcome of this is that the database remains unchanged. Another example might be that the user replaces a file of the portable device with an updated version, for example an updated text file. Again, from the point of view of the database, no actual modification has been made, so that in this case also, the step of updating the database is not necessary and can be dispensed with.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 is a block diagram of a system for updating content of a portable device according to an embodiment of the invention.

FIG. 2 is a block diagram of a file showing file header and file content.

FIG. 3 is a schematic diagram of a portable device according to an embodiment of the invention.

FIG. 4 is a flowchart illustrating the steps of a method of updating content of a portable device according to an embodiment of the invention.

### DESCRIPTION OF EMBODIMENTS

In the drawings, like numbers refer to like objects throughout.

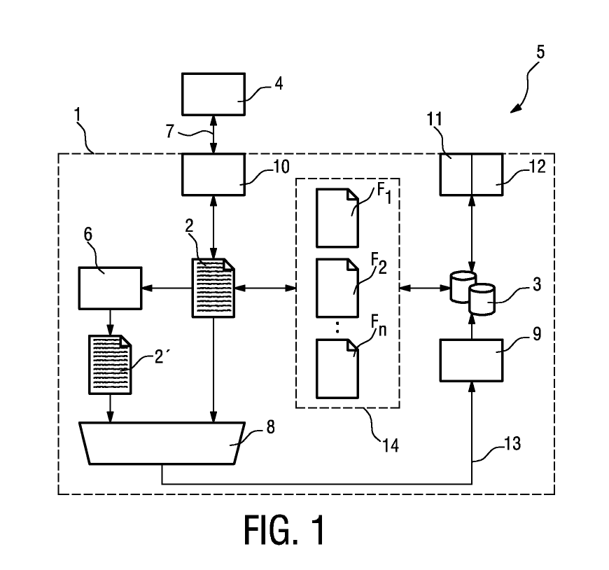

In the system 5 shown in FIG. 1 for updating content of a portable device 1, the portable device 1 can communicate with a main device 4 by means of an interface 7. The portable device 1 can be any kind of player, such as a music player, while the main device 4 can be a personal computer, a terminal of a network such as the internet etc., or any other device capable of managing files in an electronic format. Commands and data are transferred between the main device 4 and the portable device 1 via the interface 7. An interface unit 10 of the portable device 1 performs any input/output conversion required by a transfer protocol. For the sake of clarity, only the components of the portable device 1 relative to the invention are shown in FIG. 1. It is understood that the portable device 1 comprises all other necessary components, such as user interface, playback controller, memory, etc.

Any files F₁, F₂, . . . Fₙ downloaded from an external source by means of the main device 4 and stored on the portable device 1 are managed in a structured file system. All relevant structural information regarding the file system is recorded in a file system table 2, which reflects the current status of the files F₁, F₂, . . . Fₙ stored on the portable device 1, containing information regarding file size, file type, location on the portable device 1, etc.

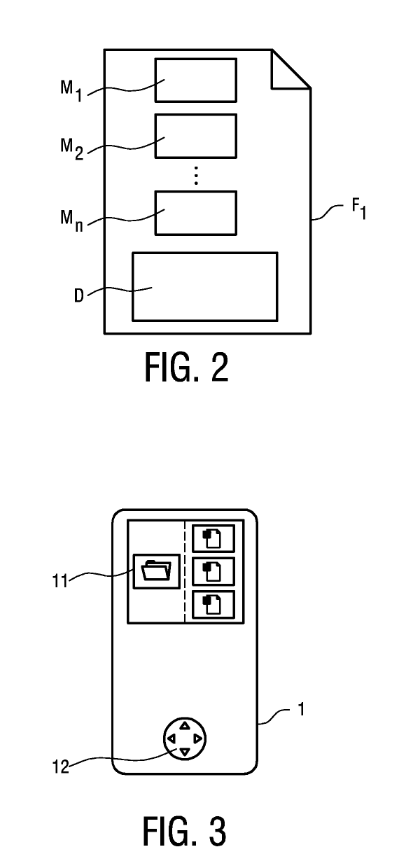

The user of the portable device 1 is interested in the content of the files F₁, F₂, . . . Fₙ. A database 3 is used to obtain pertinent information from the files F₁, F₂, . . . Fₙ and to display this information to the user by means of visual feedback, for example in a display 11. The user can specify categories in which the files are to be categorized, for example “U2”, “90s Rock”, etc. FIG. 2 shows, in a simplified representation, metadata elements M₁, M₂, . . . Mₙ of a file F₁ and the actual data D of the file F₁. It is understood that the other content files F₂, . . . Fₙ can also comprise a similar structure. The structure and number of metadata elements M₁, M₂, . . . Mₙ can differ between the different content files F₁, F₂, . . . Fₙ. The metadata elements M₁, M₂, . . . Mₙ of a music file might describe the artist, the name of the album associated with this music file, music genre, year of release, the title of the song, etc. Each music file is categorized by the database so that it appears in each relevant folder. For example, the music track with title “Zoo Station” can be categorized into all of the folders “U2”, “Irish Bands”, “90s Rock”, etc.

The user of the portable device 1 can see, by means of a display 11, a selection of the files currently stored in the portable device 1. Usually, the information shown in the display 11 of such a small device is kept to a minimum for the sake of clarity. For example, as shown in FIG. 3, elements of the database are shown to the user by means of symbols and text. Here, symbols representing folders and files can show the user at a glance the files available on the portable device 1. For example, a top level view in the display might show the folders created by the user, such as “90s Rock”, “Irish Bands”, . . . . By means of a multi-way button 12 of the user interface, the user can visually navigate through the database 3 by traversing the hierarchies until the desired level is shown in the display 11, and can then select a track for listening. The user might use the button 12 to select and open the folder “Irish Bands”. A next level of hierarchy can show folders titled “U2”, “Clannad”, etc. An alternative user interface might comprise a touch-sensitive region for user input. Moreover any other suitable user interface may be used.

As mentioned above, data is transferred from an external device 4 to the portable device 1, for example whenever the user downloads one or more new files F₁, F₂, . . . , Fₙ to the portable device 1, or whenever the user removes one or more files F₁, F₂, . . . , Fₙ from the portable device 1. These changes or modifications are all tracked by the file system and reflected in the file system table 2. When activity is first detected on the interface 7 between the portable device 1 and the main device 4, a replication unit 6 creates and stores a file system table replica 2′. This copy 2′ of the file system table 2 reflects the state of the file system table 2 before this state is modified by the addition, removal or modification of content files F₁, F₂, . . . Fₙ.

To determine the update required so that the database 3 also reflects these modifications, the modified file system table 2 is compared to the file system table replica 2′ in a comparator 8. Since the structure of the file system table 2 is essentially the same as that of the file system table replica 2′, the comparator 8 can easily deduce which files F₁, F₂, . . . Fₙ have been created, deleted, or otherwise modified. The comparator 8 supplies a database update unit 9 with the update information 13 it has deduced, so that this database update unit 9 can make the necessary changes to the database 3.

Any new or modified files F₁, F₂, . . . Fₙ are identified, and their metadata M₁, M₂, . . . Mₙ is read by the database 3. The metadata elements M₁, M₂, . . . Mₙ of each new or modified file F₁, F₂, . . . Fₙ are examined to determine into which category the database 3 should place the file F₁, F₂, . . . Fₙ. Database references to files F₁, F₂, . . . , Fₙ which have been deleted from the file system are also deleted from the database 3, so that the database 3 is automatically updated to reflect the actual state of the file system. Changes to the file system can then be viewed in the display 11 of the portable device 1.

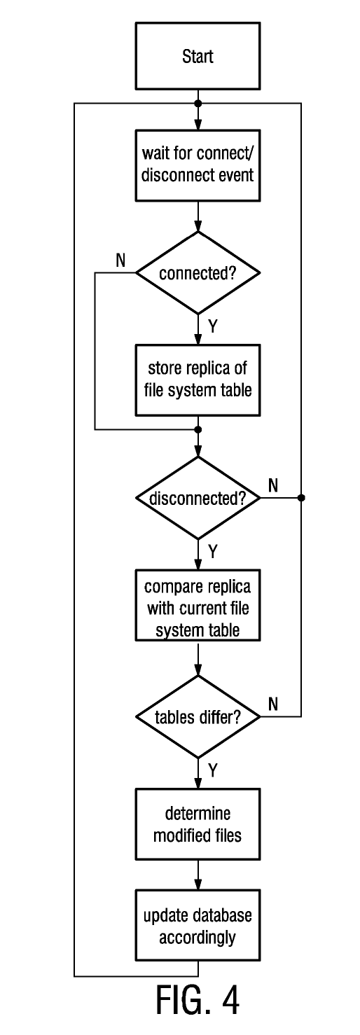

The method of updating the content of a portable device is further illustrated in FIG. 4, which shows the steps of the method in a flowchart. Initially, the system waits for a connect/disconnect event. Once such an event occurs, the system checks to see whether the portable device is now connected to an external device. If so, a copy or replica of the file system table is made, and stored on the storage medium. If the event was a disconnect event, i.e. the portable device is now no longer connected to the external device, the replica of the file system table is compared to the current or modified file system table. If no difference is detected, then the database does not require updating, and the system continues to wait for a connect/disconnect event. If, however, a difference is detected between the file system table replica and the current file system table, the tables are examined in detail to identify the changes, which have been caused by creation/deletion/modification of a file or files. Using this information, the database is updated. Once this step is complete, the database reflects the changes, which have been made to the file system.

Although the present invention has been disclosed in the form of preferred embodiments and variations thereon, it will be understood that numerous additional modifications and variations could be made thereto without departing from the scope of the invention.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1-10. (canceled)

11. A method of updating content of a portable device (1) comprising a file system (14) for managing the content (F₁, F₂, . . . Fₙ), an associated file system table (2), and a content database (3) for presenting the content (F₁, F₂, . . . Fₙ) according to content metadata (M₁, M₂, . . . Mₙ), which method comprises the steps of:
establishing a connection between the portable device (1) and a main device (4);
replicating in the portable device at least part of the current file system table (2) to give a primary file system table replica (2′);
modifying the content (F₁, F₂, . . . Fₙ) of the portable device (1) by means of the main device (4) thereby creating a modified file system table on the portable device;
comparing in the portable device the modified file system table (2) to the primary file system table replica (2′);
updating in the portable device the content database (3) of the portable device (1) on the basis of the comparison results.

12. A method as claimed in claim 11, wherein the modified file system table (2) of the portable device (1) is automatically compared to the primary file system table replica (2′) upon disconnection from the main device (4).

13. A method as claimed in claim 11, wherein the step of updating the content database (3) comprises scanning the content metadata and building the content database (3) according to information obtained from the content metadata (M₁, M₂, . . . Mₙ).

14. A method as claimed in claim 11, wherein the step of updating the content database (3) comprises removing its references to content (F₁, F₂, . . . Fₙ) that has been deleted from the portable device (1) and/or generating references to content (F₁, F₂, . . . , Fₙ) that has been added to the portable device (1).

15. A method as claimed in claim 11, wherein the file system table (2) is replicated at intervals while the portable device (1) is connected to the main device (4), and the content database (3) is updated accordingly.

16. A method as claimed in claim 11, wherein the file system table (2) is replicated after the content database (3) has been updated to provide a primary file system table replica (2′) for a further update.

17. A method as claimed in claim 11, wherein the file system table (2) is replicated whenever a command transferred between the portable device (1) and the main device (4) indicates that a modification has been made to the content (F₁, F₂, . . . Fₙ) of the portable device (1).

18. A method as claimed in claim 16, wherein the current file system table (2) is replicated at a particular point in time to give a secondary file system table replica, and wherein, after the content database (3) has been updated to reflect the modifications described by the differences between the secondary file system table replica and the primary file system table replica, the primary file system table replica is replaced by the secondary file system table replica to give a new primary file system table replica.

19. A system (5) for updating content (F₁, F₂, . . . Fₙ) of a portable device (1), comprising
a file system (14) in the portable device for managing the content (F₁, F₂, . . . Fₙ) of the portable device (1) and an associated file system table (2);
a content database (3) in the portable device for presenting the content (F₁, F₂, . . . , Fₙ) of the portable device (1) according to content metadata (M₁, M₂, . . . Mₙ);
a replication unit (6) in the portable device for replicating at least part of the file system table (2) to give a primary file system table replica (2′);
a main device (4) for modifying the content (F₁, F₂, . . . Fₙ) of the portable device (1) thereby creating a modified file system table on the portable device;
a connecting means (10) in the portable device for establishing a connection (7) between the portable device (1) and the main device (4);
a comparator (8) in the portable device for comparing the modified file system table (2) to the primary file system table replica (2′);
an update unit (9) in the portable device for updating the content database (3) of the portable device (1) on the basis of the comparison results.

20. A portable device (1), comprising:
a file system (14) for managing the content (F₁, F₂, . . . Fₙ) of the portable device (1);
an associated file system table (2);
a content database (3) for presenting the content (F₁, F₂, . . . Fₙ) of the portable device (1) according to content metadata (M₁, M₂, . . . Mₙ);
a connecting means (10) for establishing a connection to a main device (4) for modifying the content (F₁, F₂, . . . Fₙ) of the portable device (1) thereby creating a modified file system table on the portable device;
a replication unit (6) for replicating at least part of the file system table (2) to give a primary file system table replica (2′);
a comparator (8) for comparing the modified file system table (2) to the primary file system table replica (2′);
an update unit (9) for updating the content database (3) of the portable device (1) on the basis of the comparison results.
